(19) United States
(12) Patent Application Publication
(10) Pub. No.: US 2011/0136034 A1
(43) Pub. Date: Jun. 9, 2011

(54) GAS DISTRIBUTOR DEVICE

(75) Inventor: Gerhard Huppmann, Feldkirchen-Westerham (DE)

(73) Assignee: MTU Onsite Energy GmbH

(21) Appl. No.: 12/957,658

(22) Filed: Dec. 1, 2010

(30) Foreign Application Priority Data
Dec. 7, 2009 (DE) 10 2009 057 339.9

(51) Int. Cl. H01M 8/04; H01M 8/24

(52) U.S. Cl. 429/460

(57) ABSTRACT

A gas distributor device for a fuel cell arrangement is provided. The device has a number of fuel cells with a gas distributor combined to form a fuel cell stack. The stack features a inner side and an outer side, a supporting structure or supporting device and a sealing device. The sealing device is on the inner side of the gas distributor and the supporting device is on the outer side of the gas distributor. An elastic element is between the outer side of the gas distributor and the supporting device. The elastic element executes a horizontal force to the supporting device in the direction of the sealing device, as well as corresponding fuel cell arrangement.

The existing invention pertains to a gas distributor device in accordance with the preamble of claim 1 and a fuel cell assembly in accordance with the preamble of claim 12.

A sealing device for a gas distributor (manifold) of a fuel cell arrangement, which has a fuel cell stack, is known from the publication U.S. Pat. No. 4,414,294. In a state where the sealing device is mounted to the fuel cell stack, it seals off an anode gas chamber of a gas distributor or a cathode gas chamber of the same. The sealing device consists of sealing elements that are connected to each other in the form of chain link and are made of an electrically insulating material. During the operation of fuel cells there are however relative movements between the fuel cell stack and the sealing device (made of rigid material) or the gas distributor made of similar rigid material. These movements are triggered e.g. through increase in temperature from room temperature to operating temperature (approx. 650° C.) or through different material pairings or chemical processes. These relative movements lead to a reduced sealing effect so that gas from the anode gas chamber can enter into the cathode gas chamber (and vice versa), which may finally lead to a destruction of the fuel cell assembly.

To achieve an increased sealing effect, the use of a gas distributor made of a flexible material is suggested in US 2006/0141325 A1. Even the use of such a gas distributor cannot reduce the leakage rate arising through the occurrence of relative movements during operation in a desired measure or prevent them completely.

A gas distributor device of fuel cell assembly is known from the publication WO 2008/110292 A1. Apart from a gas distributor, the gas distributor device described there also covers a sealing device. Corresponding to state of the art technology the sealing device features a sealing frame having a number of longitudinal sealing elements made of dielectric material arranged between the longitudinal edge of the gas distributor and the fuel cell stack, where the said sealing elements are arranged in a longitudinally movable fashion and are arranged next to each other in a gap-free fashion on front side. Furthermore the sealing device features a tension system having tension devices for producing a mechanical tension pressing the longitudinal sealing elements together in the longitudinal direction. This invention deals with a relatively extensive design.

Furthermore a fuel cell arrangement is known from the publication JP 2009 054 378 AA, in which a sealing element as well as a gas distributor is fixed to the end plates of the fuel cell arrangement with the help of spring-loaded retaining bolts.

Moreover the publication DE 11 2004 001 314 T5 reveals a fuel cell assembly where a sealing is arranged at the inner side of the gas distributor.

Based on the aforesaid state of technology it is the task of the existing invention to specify a gas distributor device for a fuel cell arrangement having a number of fuel cells combined to form a fuel cell stack, which exhibits a high sealing effect and simultaneously having as simple a design as possible. Furthermore it is the task of the existing invention to specify a corresponding fuel cell arrangement.

This task is solved through a gas distributor device with the properties of claim 1, as well as a fuel cell arrangement with the properties of the patent claim 12.

According to the invention the gas distributor device for a fuel cell arrangement having a number of fuel cells combined to form a fuel cell stack features a gas distributor with an inner side and an outer side, a supporting structure or supporting device and a sealing device. The sealing device is arranged on the inner side of the gas distributor, while the supporting structure is arranged on the outer side of the gas distributor.

There is an elastic element arranged between the outer side of the gas distributor and the supporting structure, for example in the form of one or more springs, especially compression springs and/or of one or more pressure-controlled bellows, which executes a force horizontal to the supporting structure in the direction of sealing device. Through this, relative movements between supporting structure and fuel cell stack can be absorbed when the sealing effect is uniform. If the gas distributor is made of an elastic material, then the relative movements occurring in the operation of fuel cells can be absorbed or compensated better.

Other properties and advantages of the invention result from the following description of a possible embodiment of the invention, with the help of the attached figure, which shows details significant to the invention and from the claims. The individual properties can be implemented either for itself or to several forms in any combinations for a variant of the invention.

A possible embodiment of a fuel cell arrangement in line with the invention is explained below with the help of the attached drawing. It shows:

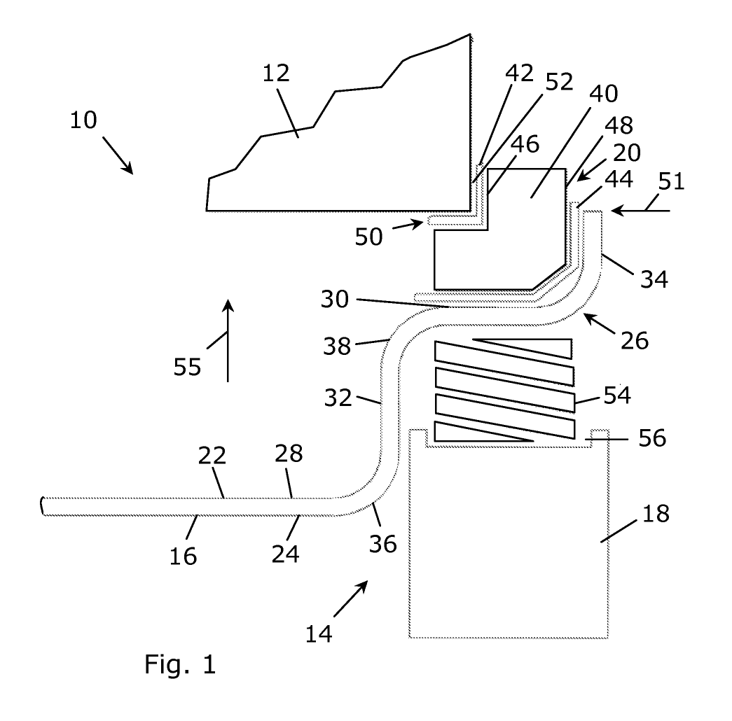

FIG. 1 a fuel cell assembly in accordance with the possible embodiment of the invention mentioned above in a schematic representation.

FIG. 1 shows a fuel cell arrangement 10 in line with the invention, which features a fuel cell stack 12 (stack), as well as a gas distributor device 14. The fuel cell stack 12 is made of several fuel cells, which are connected to the fuel cell stack 12 in a known way.

The gas distributor device 14 features a gas distributor 16 for the discharge and supply of gas streams i.e. fuel gas, oxidation gas and flue gas, a supporting device or supporting structure 18 and a sealing device 20. The gas distributor 16, which is made of an elastic material (in the embodiment described made of metal), is built in the form of a deep-drawn tub and features an inner side 22 and an outer side 24. The side of the gas distributor 16 that is turned towards the fuel cell stack 12 is designated as inner side 22, while the side of the gas distributor 16 that is turned away from the fuel cell stack 12 is designated as outer side.

The gas distributor 16 is designed at its edge areas 26 (in the alternative embodiments at least one of its edge areas) in the form of steps, so that it has a base surface 28 (the base of the gas distributor 16 built in the form of a tub) and a step surface 30 as well as first step section 32 and a second step section 34. The first and second step sections 32, 34 are arranged to the base surface 28 and the step surface 30 at an angle of 90°, whereby the angles are built through “sharp edges” but through a first arched section 36 and a second arched section 38 of the gas distributor 16.

The sealing device 20, which features a structured ceramic in the embodiment described i.e. segment-type sealing elements 40 made of a ceramic material, is arranged on the inner side 22 of the gas distributor 16. For this the step surfaces 30 and the second step section 34 of the gas distributor 16 are provided on the inner side 22 of the same for adapting the sealing device 20. Apart from the sealing elements 40, the sealing device 20 features an inner sealing felt 42 and an outer sealing felt 44. The ceramic sealing elements 40 (dielectrics) as well as the sealing felts 42, 44 insulate the fuel cell stack 12 (which delivers a direct current in operation) electrically against the gas distributor 16 (which lies on the ground).

The inner sealing felt 42 is arranged between the fuel cell stack 12 and the side 46 of the sealing element 40 that is turned towards the fuel cell stack 12, while the outer sealing felt 44 is arranged between side 48 of the sealing element 40 and step surface 30 that is turned towards the gas distributor 16 as well as the second step section 34 (on the inner side of the gas distributor 16). For taking in the fuel cell stack 12, the sealing elements 40 feature corresponding block-shaped material recess 50, through which a large sealing surface 52 forms at the fuel cell stack 12.

The second step section 34 of the gas distributor 16 is designed to be under stress so that it can execute a force on the sealing device 20 in the direction of its inner side i.e. in the direction to the fuel cell stack 12 (implied through arrow 51). This leads to a safe attachment of the inner sealing felt 42 to the fuel cell stack 12 during the movements of the fuel cell stack 12 in the corresponding directions.

The above mentioned supporting structure 18, which is designed in the form of a frame in the embodiment described, is arranged at the outer side 24 of the gas distributor 16 and is used for taking in the fuel cell stack 12 including sealing device 20 and gas distributor 16. There is an elastic element between the outer side 24 of the gas distributor 16 and the supporting structure 18 in the form of several compression springs 54 arranged next to each other (due to sectional view only one compression spring 54 can be seen in FIG. 1), which executes a horizontal force to the supporting structure 18 in the direction of the sealing device 20 (implied through arrow 55) and can take a three-dimensional movements of the fuel cell stack 12 at a constant sealing effect of the sealing device 20.

By using an elastic element the relative movements between the supporting structure 18 and the fuel cell stack 12 can be balanced or absorbed due to thermal or material-specific causes, without this leading to a noteworthy loss at the sealing device. With it the anode gas chamber and the cathode gas chamber remain effective against each other and are also effectively sealed against the environment and the fuel cell stack 10 maintains its functionality. The supporting structure 18 features corresponding material recesses in the form of blind holes 56 for the partial accommodation of the compression springs 54 and through this it is ensured that the compression springs 54 remain in their desired position and cannot slip out.

While the elastic element consists of a multiple compression springs 54 in the embodiment mentioned above, other elastic elements e.g. other spring types or a pressure-controlled spring bellow or multiple pressure-controlled bellows are possible for alternative embodiments. Even combinations of one or multiple springs with a pressure-controlled spring bellow or multiple pressure-controlled spring bellows and/or other suitable elastic components are also possible. To secure the position of the elastic element relative to the supporting structure 18, not only material recesses in the form of blind holes 56 are possible. According to the design of the elastic elements even nut-shaped or similar recess, which facilitates a safe grip, is also possible. The pressure-controlled spring bellow or the pressure-controlled spring bellow can be subject to a pneumatic or a hydraulic action mechanism.

Although the invention is described with the help of an embodiment with fixed property combination, it also covers other possible and advantageous combinations, as they are specified, but not exhaustive, by the dependent claims. All the features disclosed in the application documents are claimed as important to the invention, insofar as they are new to the current state of technology either individually or in combination.

1. A gas distributor device for a fuel cell arrangement having a number of fuel cells with a gas distributor connected to a fuel cell stack, which features a inner side turned towards the fuel stack and an outer side turned away from the fuel cell stack, a supporting device and a sealing device, where the sealing device is arranged on the inner side of the gas distributor and where the supporting device is arranged on the outer side of the gas distributor and characterized in such way a way that the supporting device is used for accommodating the fuel cell stack including sealing device and gas distributor, where an elastic element is arranged between the outer side of the gas distributor and the supporting device, which in turn executes a horizontal force to the supporting device in the direction of the sealing device.

2. The gas distributor device of claim 1, where the gas distributor is made of an elastic material.

3. The gas distributor device of claim 1, where the elastic element features one or multiple springs.

4. The gas distributor device of claim 1, where the elastic element features a pressure-controller spring bellow or several pressure-controlled spring bellows.

5. The gas distributor device of claim 4, where at least one pressure-controlled spring bellow is based on a hydraulic action mechanism.

6. The gas distributor device of claim 4, where at least one pressure-controlled spring bellow is based on a pneumatic action mechanism.

7. The gas distributor device of claim 1, where the supporting device features a material for partial accommodation of the elastic element.

8. The gas distributor device of claim 1, where the gas distributor is shaped as a step at least one of its edges and features a base surface and a step surface and a first and second step section to the base surface and is arranged relative to the step surface (30) at an angle of 90°.

9. The gas distributor device of claim 8, where the step surface and the second step section of the gas distributor are provided on the inner side of the gas distributor for accommodating the sealing device.

10. The gas distributor device of claim 9, where the step section is designed to be under tension in such a way that it executes a force on the sealing device in the direction of its inner side.

11. The gas distributor device of claim 1, where the sealing device features a structured ceramic having a material recess for accommodating the fuel cell stack.

12. A fuel cell assembly having a number of fuel cells combined to form a fuel cell stack in combination with the gas distributor device of claim 1.
